(19) United States
(12) Patent Application Publication
(10) Pub. No.: US 2021/0357763 A1
(43) Pub. Date: Nov. 18, 2021

(54) METHOD AND DEVICE FOR PERFORMING BEHAVIOR PREDICTION BY USING EXPLAINABLE SELF-FOCUSED ATTENTION

(71) Applicant: Stradvision, Inc., Pohang-si (KR)

(72) Inventors: Hongmo JE, Pohang-si (KR); Dongkyu YU, Pohang-si (KR); Bongnam KANG, Pohang-si (KR); Yongjoong KIM, Pohang-si (KR)

(21) Appl. No.: 17/135,396

(22) Filed: Dec. 28, 2020

Related U.S. Application Data
(60) Provisional application No. 63/026,424, filed on May 18, 2020.

(51) Int. Cl. G06N 3/08; G06N 3/04

(52) U.S. Cl. CPC G06N 3/088; G06N 3/0445; G06N 3/0454

(57) ABSTRACT

A method for predicting behavior using explainable self-focused attention is provided. The method includes steps of: a behavior prediction device, (a) inputting test images and the sensing information acquired from a moving subject into a metadata recognition module to apply learning operation to output metadata, and inputting the metadata into a feature encoding module to output features; (b) inputting the test images, the metadata, and the features into an explaining module to generate explanation information on affecting factors affecting behavior predictions, inputting the test images and the metadata into a self-focused attention module to output attention maps, and inputting the features and the attention maps into a behavior prediction module to generate the behavior predictions; and (c) allowing an outputting module to output behavior results and allowing a visualization module to visualize and output the affecting factors by referring to the explanation information and the behavior results.

### CROSS REFERENCE TO RELATED APPLICATION

This application claims the benefit of priority to U.S. Provisional Patent Application No. 63/026,424, filed on May 18, 2020, the entire contents of which being incorporated herein by reference.

### FIELD OF THE DISCLOSURE

The present disclosure relates to behavior prediction; and more particularly, to a method and a device for performing the behavior prediction by using explainable self-focused attention.

### BACKGROUND OF THE DISCLOSURE

Recently, methods of performing object identification and the like making use of machine learning are being studied.

Deep learning, which is one type of the machine learning, uses a neural network with several hidden layers between an input layer and an output layer, and shows a high performance in object identification.

And, the deep learning is used in various industries such as autonomous vehicle industry, autonomous airplane industry, autonomous robot industry, etc.

Especially, behavior prediction has been in development recently which predicts behavior, e.g., a trajectory, of an object, using perception, localization and mapping based on given videos and sensor information.

By referring to FIG. 1, in a conventional autonomous vehicle, a behavior prediction device acquires (1) a video taken while the autonomous vehicle is being driven and (2) sensing information detected by sensors of the autonomous vehicle, through a video & sensing information acquisition module 10, and acquires metadata corresponding to images corresponding to the each of frames in the video and the sensing information through a metadata recognition module 20. Herein, the metadata includes (1) analysis results on the images, such as bounding boxes of objects, traffic lights, traffic signs, etc., which are acquired by analyzing the images based on deep learning and (2) ego-vehicle poses, map information, etc. based on the sensing information. And, the behavior prediction device encodes the metadata, to thereby generate features for behavior prediction, through a feature encoding module 30, and applies learning operation to the features, to thereby perform on the behavior prediction of the objects, that is, trajectories of the objects, through a behavior prediction module 40 based on the deep learning, and outputs the behavior prediction of the objects through an outputting module 50.

Meanwhile, to predict the behavior, an LSTM (Long Short-Term Memory) is used conventionally for analysis of consecutive images, and recently a performance of the prediction is improved by using a GAN (Generative Adversarial Network) at least part of which is configured as the LSTM.

However, a deep learning network is not explainable in general. That is, one can hardly understand why the deep learning network has arrived at such a decision or which feature has affected the prediction.

Therefore, a conventional behavior prediction network has been improved by merely adding more complex models and using supplemental techniques without regard to features actually affecting the behavior, and as a result, a device using the conventional behavior prediction network as such over-consumes computing resources.

### SUMMARY OF THE DISCLOSURE

It is an object of the present disclosure to solve all the aforementioned problems.

It is another object of the present disclosure to allow information on one or more affecting factors, determined as affecting one or more behavior predictions by a behavior prediction network, to be provided to a user.

It is still another object of the present disclosure to allow the user to pay attention to one or more areas of interest (AOIs) to be marked when the behavior predictions of a specific object is performed by the behavior prediction network.

It is still yet another object of the present disclosure to efficiently improve a performance of the behavior prediction network by using the affecting factors determined as affecting the behavior predictions.

In order to accomplish the objects above, distinctive structures of the present disclosure are described as follows.

In accordance with one aspect of the present disclosure, there is provided a method for predicting behavior using explainable self-focused attention, including steps of: (a) a behavior prediction device, if (1) a video for testing taken by a camera mounted on a moving subject where the behavior prediction device is installed and (2) sensing information for testing detected by one or more sensors mounted on the moving subject are acquired, performing or supporting another device to perform (i) a process of inputting each of one or more test images corresponding to each of one or more frames for testing on the video for testing and each piece of the sensing information for testing corresponding to each of the frames for testing into a metadata recognition module, to thereby allow the metadata recognition module to apply at least one learning operation to the test images and the sensing information for testing and thus to output each piece of metadata for testing corresponding to each of the frames for testing, and (ii) a process of inputting the metadata for testing into a feature encoding module, to thereby allow the feature encoding module to encode the metadata for testing and thus to output each of features for testing, corresponding to each of the frames for testing; (b) the behavior prediction device performing or supporting another device to perform (i) a process of inputting each of the test images, each piece of the metadata for testing, and each of the features for testing into an explaining module, to thereby allow the explaining module to generate each piece of explanation information for testing, corresponding to each of the frames for testing, on each of affecting factors for testing determined as affecting one or more behavior predictions for testing for each of the frames for testing, (ii) a process of inputting each of the test images and each piece of the metadata for testing into a self-focused attention module, to thereby allow the self-focused attention module to output, through the learning operation, each of attention maps for testing corresponding to each of the frames for testing wherein each of the attention maps for testing is created by marking one or more areas of interest (AOIs) for testing, to be used for the behavior predictions for testing, on each of the test images, and (iii) a process of inputting each of the features for testing and each of the attention maps for testing into a behavior prediction module, to thereby allow the behavior prediction module to analyze the features for testing and the attention maps for testing and predict each of one or more behaviors of each of one or more objects for testing, through the learning operation, and thus generate each of the behavior predictions for testing; and (c) the behavior prediction device performing or supporting another device to perform (i) a process of allowing an outputting module to output each of behavior results for testing, corresponding to each of the behavior predictions for testing, of each of the objects for testing and (ii) a process of allowing a visualization module to visualize and output the affecting factors for testing by referring to the explanation information for testing and the behavior results for testing.

As one example, a learning device has trained the explaining module and the self-focused attention module by performing or supporting another device to perform: (i) a process of inputting each of training images corresponding to each of frames for training and each piece of sensing information for training corresponding to each of the frames for training into the metadata recognition module, to thereby allow the metadata recognition module to output each piece of metadata for training corresponding to each of the frames for training, (ii) a process of inputting the metadata for training into the feature encoding module, to thereby allow the feature encoding module to encode the metadata for training and thus to output each of features for training, corresponding to each of the frames for training, (iii) a process of inputting each of the training images, each piece of the metadata for training, and each of the features for training into the explaining module, to thereby allow the explaining module to generate each piece of explanation information for training corresponding to each of the frames for training, on each of affecting factors for training determined as affecting one or more behavior predictions for training for each of the frames for training, (iv) a process of inputting each piece of the explanation information for training and each piece of the metadata for training into the self-focused attention module, to thereby allow the self-focused attention module to analyze the explanation information for training and the metadata for training and thus to output each of attention maps for training corresponding to each of the frames for training wherein each of the attention maps for training is created by marking one or more areas of interest for training, to be used for the behavior predictions for training, corresponding to each of the frames for training, and (v) a process of minimizing (v-1) each of one or more explanation losses calculated by referring to each piece of the explanation information for training and its corresponding each of explanation ground truths and (v-2) each of one or more attention losses calculated by referring to each of the attention maps for training and its corresponding each of attention ground truths.

As one example, at the step of (b), the behavior prediction device performs or supports another device to perform a process of instructing the explaining module to (i) reduce dimensions of the test images, the metadata for testing, and the features for testing, to thereby generate each of latent features for testing corresponding to each of the frames for testing, through an encoder of an autoencoder and (ii) reconstruct each of the latent features for testing and mark each of the affecting factors for testing as the areas of interest for testing, to thereby generate each piece of the explanation information for testing, through a decoder of the autoencoder.

As one example, at the step of (c), the behavior prediction device performs or supports another device to perform a process of instructing the visualization module to mark at least one target object as one of the areas of interest for testing on each of the test images and to output each of the marked test images, by referring to the behavior predictions for testing and the explanation information for testing, wherein the target object is determined as affecting the behavior predictions for testing in each of the frames for testing.

As one example, at the step of (b), the behavior prediction device performs or supports another device to perform a process of instructing the explaining module to (i) (i-1) apply the learning operation to the test images, the metadata for testing, and the features for testing, to thereby generate each of semantic segmentation images for testing corresponding to each of the frames for testing and (i-2) identify instance-wise areas of interest on the semantic segmentation images for testing, through the autoencoder, and (ii) generate each of explanation images for testing, corresponding to each of the frames for testing, where the affecting factors for testing are marked by referring to results of said (i-2).

As one example, at the step of (b), the behavior prediction device performs or supports another device to perform a process of instructing the explaining module to apply the learning operation to the metadata for testing, to thereby generate decision trees for testing based on the metadata for testing related to all of the objects for testing on the test images.

As one example, at the step of (c), the behavior prediction device performs or supports another device to perform a process of instructing the visualization module to output state information on at least one target object, determined as affecting the behavior predictions for testing in each of the frames for testing, by referring to the decision trees for testing and the explanation information for testing.

As one example, at the step of (a), the behavior prediction device performs or supports another device to perform a process of inputting the test images and the sensing information for testing into the metadata recognition module, to thereby allow the metadata recognition module to (1) detect environment information on surroundings of the moving subject through a perception module and (2) detect position information on the moving subject through a localization and mapping module.

As one example, each piece of the metadata for testing includes each of object bounding boxes corresponding to each of the objects for testing, each piece of pose information on the moving subject, and each piece of map information corresponding to a location of the moving subject.

As one example, the behavior prediction module includes an RNN (Recurrent Neural Network) which adopts at least one of an LSTM (Long Short-Term Memory) algorithm and an LSTM-GAN (Generative Adversarial Network) algorithm.

In accordance with another aspect of the present disclosure, there is provided a behavior prediction device for predicting behavior using explainable self-focused attention, including: at least one memory that stores instructions; and at least one processor configured to execute the instructions to perform or support another device to perform: (I) if (1) a video for testing taken by a camera mounted on a moving subject where the behavior prediction device is installed and (2) sensing information for testing detected by one or more sensors mounted on the moving subject are acquired, (i) a process of inputting each of one or more test images corresponding to each of one or more frames for testing on the video for testing and each piece of the sensing information for testing corresponding to each of the frames for testing into a metadata recognition module, to thereby allow the metadata recognition module to apply at least one learning operation to the test images and the sensing information for testing and thus to output each piece of metadata for testing corresponding to each of the frames for testing, and (ii) a process of inputting the metadata for testing into a feature encoding module, to thereby allow the feature encoding module to encode the metadata for testing and thus to output each of features for testing, corresponding to each of the frames for testing, (II) (i) a process of inputting each of the test images, each piece of the metadata for testing, and each of the features for testing into an explaining module, to thereby allow the explaining module to generate each piece of explanation information for testing, corresponding to each of the frames for testing, on each of affecting factors for testing determined as affecting one or more behavior predictions for testing for each of the frames for testing, (ii) a process of inputting each of the test images and each piece of the metadata for testing into a self-focused attention module, to thereby allow the self-focused attention module to output, through the learning operation, each of attention maps for testing corresponding to each of the frames for testing wherein each of the attention maps for testing is created by marking one or more areas of interest (AOIs) for testing, to be used for the behavior predictions for testing, on each of the test images, and (iii) a process of inputting each of the features for testing and each of the attention maps for testing into a behavior prediction module, to thereby allow the behavior prediction module to analyze the features for testing and the attention maps for testing and predict each of one or more behaviors of each of one or more objects for testing, through the learning operation, and thus generate each of the behavior predictions for testing, and (III) (i) a process of allowing an outputting module to output each of behavior results for testing, corresponding to each of the behavior predictions for testing, of each of the objects for testing and (ii) a process of allowing a visualization module to visualize and output the affecting factors for testing by referring to the explanation information for testing and the behavior results for testing.

As one example, a learning device has trained the explaining module and the self-focused attention module by performing or supporting another device to perform: (i) a process of inputting each of training images corresponding to each of frames for training and each piece of sensing information for training corresponding to each of the frames for training into the metadata recognition module, to thereby allow the metadata recognition module to output each piece of metadata for training corresponding to each of the frames for training, (ii) a process of inputting the metadata for training into the feature encoding module, to thereby allow the feature encoding module to encode the metadata for training and thus to output each of features for training, corresponding to each of the frames for training, (iii) a process of inputting each of the training images, each piece of the metadata for training, and each of the features for training into the explaining module, to thereby allow the explaining module to generate each piece of explanation information for training corresponding to each of the frames for training, on each of affecting factors for training determined as affecting one or more behavior predictions for training for each of the frames for training, (iv) a process of inputting each piece of the explanation information for training and each piece of the metadata for training into the self-focused attention module, to thereby allow the self-focused attention module to analyze the explanation information for training and the metadata for training and thus to output each of attention maps for training corresponding to each of the frames for training wherein each of the attention maps for training is created by marking one or more areas of interest for training, to be used for the behavior predictions for training, corresponding to each of the frames for training, and (v) a process of minimizing (v-1) each of one or more explanation losses calculated by referring to each piece of the explanation information for training and its corresponding each of explanation ground truths and (v-2) each of one or more attention losses calculated by referring to each of the attention maps for training and its corresponding each of attention ground truths.

As one example, at the process of (II), the processor performs or supports another device to perform a process of instructing the explaining module to (i) reduce dimensions of the test images, the metadata for testing, and the features for testing, to thereby generate each of latent features for testing corresponding to each of the frames for testing, through an encoder of an autoencoder and (ii) reconstruct each of the latent features for testing and mark each of the affecting factors for testing as the areas of interest for testing, to thereby generate each piece of the explanation information for testing, through a decoder of the autoencoder.

As one example, at the process of (III), the processor performs or supports another device to perform a process of instructing the visualization module to mark at least one target object as one of the areas of interest for testing on each of the test images and to output each of the marked test images, by referring to the behavior predictions for testing and the explanation information for testing, wherein the target object is determined as affecting the behavior predictions for testing in each of the frames for testing.

As one example, at the process of (II), the processor performs or supports another device to perform a process of instructing the explaining module to (i) (i-1) apply the learning operation to the test images, the metadata for testing, and the features for testing, to thereby generate each of semantic segmentation images for testing corresponding to each of the frames for testing and (i-2) identify instance-wise areas of interest on the semantic segmentation images for testing, through the autoencoder, and (ii) generate each of explanation images for testing, corresponding to each of the frames for testing, where the affecting factors for testing are marked by referring to results of said (i-2).

As one example, at the process of (II), the processor performs or supports another device to perform a process of instructing the explaining module to apply the learning operation to the metadata for testing, to thereby generate decision trees for testing based on the metadata for testing related to all of the objects for testing on the test images.

As one example, at the process of (III), the processor performs or supports another device to perform a process of instructing the visualization module to output state information on at least one target object, determined as affecting the behavior predictions for testing in each of the frames for testing, by referring to the decision trees for testing and the explanation information for testing.

As one example, at the process of (I), the processor performs or supports another device to perform a process of inputting the test images and the sensing information for testing into the metadata recognition module, to thereby allow the metadata recognition module to (1) detect environment information on surroundings of the moving subject through a perception module and (2) detect position information on the moving subject through a localization and mapping module.

As one example, each piece of the metadata for testing includes each of object bounding boxes corresponding to each of the objects for testing, each piece of pose information on the moving subject, and each piece of map information corresponding to a location of the moving subject.

As one example, the behavior prediction module includes an RNN (Recurrent Neural Network) which adopts at least one of an LSTM (Long Short-Term Memory) algorithm and an LSTM-GAN (Generative Adversarial Network) algorithm.

In addition, recordable media readable by a computer for storing a computer program to execute the method of the present disclosure is further provided.

### BRIEF DESCRIPTION OF THE DRAWINGS

The following drawings to be used to explain example embodiments of the present disclosure are only part of example embodiments of the present disclosure and other drawings can be obtained based on the drawings by those skilled in the art of the present disclosure without inventive work.

FIG. 1 is a block diagram of a conventional behavior prediction device.

FIG. 2 is a drawing schematically illustrating a behavior prediction device which performs one or more behavior predictions by using explainable self-focused attention in accordance with one example embodiment of the present disclosure.

FIG. 3 is a block diagram illustrating a configuration of the behavior prediction device which performs the behavior predictions by using the explainable self-focused attention in accordance with one example embodiment of the present disclosure.

FIG. 4 is a drawing schematically illustrating an example of generating explanation information for the behavior predictions by using the explainable self-focused attention in accordance with one example embodiment of the present disclosure.

FIG. 5 is a drawing schematically illustrating another example of generating the explanation information for the behavior predictions by using the explainable self-focused attention in accordance with one example embodiment of the present disclosure.

FIGS. 6A and 6B are drawings schematically illustrating processes of generating self-focused attention for the behavior predictions by using the explainable self-focused attention in accordance with one example embodiment of the present disclosure.

FIG. 7 is a drawing schematically illustrating visualization of the explanation information for the behavior predictions by using the explainable self-focused attention in accordance with one example embodiment of the present disclosure.

FIG. 8 is a drawing schematically illustrating processes of training an explaining module and a self-focused attention module in the behavior prediction device for the behavior predictions by using the explainable self-focused attention in accordance with one example embodiment of the present disclosure.

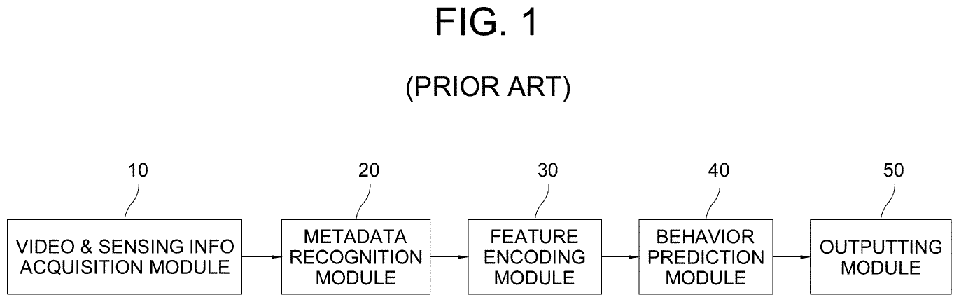

### DETAILED DESCRIPTION OF THE PREFERRED EMBODIMENTS

Detailed explanation on the present disclosure to be made below refer to attached drawings and diagrams illustrated as specific embodiment examples under which the present disclosure may be implemented to make clear of purposes, technical solutions, and advantages of the present disclosure. These embodiments are described in sufficient detail to enable those skilled in the art to practice the invention.

Besides, in the detailed description and claims of the present disclosure, a term “include” and its variations are not intended to exclude other technical features, additions, components or steps. Other objects, benefits and features of the present disclosure will be revealed to one skilled in the art, partially from the specification and partially from the implementation of the present disclosure. The following examples and drawings will be provided as examples but they are not intended to limit the present disclosure.

Moreover, the present disclosure covers all possible combinations of example embodiments indicated in this specification. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, similar reference numerals refer to the same or similar functionality throughout the several aspects.

To allow those skilled in the art to carry out the present disclosure easily, the example embodiments of the present disclosure by referring to attached diagrams will be explained in detail as shown below.

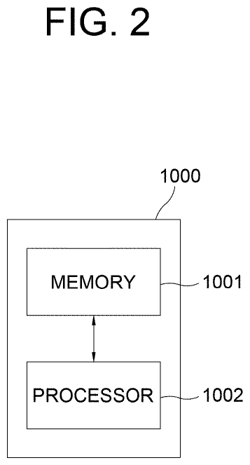

FIG. 2 is a drawing schematically illustrating a behavior prediction device which performs one or more behavior predictions by using explainable self-focused attention in accordance with one example embodiment of the present disclosure. By referring to FIG. 2, the behavior prediction device 1000 may include a memory 1001 for storing instructions to perform on the behavior predictions by using the explainable self-focused attention and a processor 1002 for performing the behavior predictions by using the explainable self-focused attention according to the instructions in the memory 1001.

Specifically, the behavior prediction device 1000 may typically achieve a desired system performance by using combinations of at least one computing device and at least one computer software, e.g., a computer processor, a memory, a storage, an input device, an output device, or any other conventional computing components, an electronic communication device such as a router or a switch, an electronic information storage system such as a network-attached storage (NAS) device and a storage area network (SAN) as the computing device and any instructions that allow the computing device to function in a specific way as the computer software.

The processor of the computing device may include hardware configuration of MPU (Micro Processing Unit) or CPU (Central Processing Unit), cache memory, data bus, etc. Additionally, the computing device may further include software configuration of OS and applications that achieve specific purposes.

However, such description of the computing device does not exclude an integrated device including any combination of a processor, a memory, a medium, or any other computing components for implementing the present disclosure.

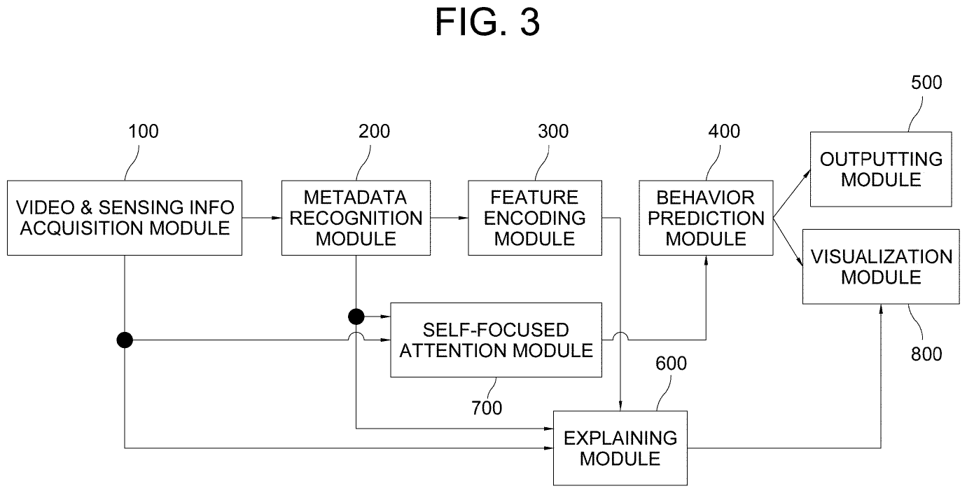

Also, by referring to FIG. 3, the behavior prediction device 1000 may include a video & sensing information acquisition module 100, a metadata recognition module 200, a feature encoding module 300, a behavior prediction module 400, an outputting module 500, an explaining module 600, a self-focused attention module 700, and a visualization module 800.

Processes of the behavior predictions with the explainable self-focused attention by using the behavior prediction device 1000 are described below. The description below mainly explains an example of an autonomous vehicle as a device for the behavior predictions of nearby objects. But the scope of the present disclosure is not limited thereto and also applies to autonomous aircrafts, autonomous robots, mobile devices, etc.

By referring to FIG. 3, the behavior prediction device 1000 may perform or support another device to perform a process of acquiring (1) a video taken by at least one camera mounted on a moving subject, e.g., the autonomous vehicle, where the behavior prediction device 1000 is installed and (2) sensing information acquired by one or more sensors mounted on the moving subject.

Herein, the behavior prediction device 1000 may perform or support another device to perform a process of acquiring (1) a video for testing taken by the camera and (2) sensing information for testing detected by the sensors of the autonomous vehicle, e.g., an ego-vehicle, while the autonomous vehicle is being driven, through the video & sensing information acquisition module 100.

Meanwhile, the video is described above as acquired from the camera, but the scope of the present disclosure is not limited thereto, and the video may be acquired by using a LiDAR, a radar or through sensor fusion technology. Also, the acquired video may include environment information on areas corresponding to specific visual fields seen from the moving subject or environment information on surroundings of the moving subject.

Next, if the video for testing and the sensing information for testing are acquired, the behavior prediction device 1000 may perform or support another device to perform a process of inputting each of one or more test images corresponding to each of one or more frames for testing on the video for testing and each piece of the sensing information for testing corresponding to each of the frames for testing into the metadata recognition module 200, to thereby allow the metadata recognition module 200 to apply at least one learning operation to each of the test images and each piece of the sensing information for testing and thus to output each piece of metadata for testing corresponding to each of the frames for testing.

Specifically, the behavior prediction device 1000 may perform or support another device to perform a process of inputting each of the test images and each piece of the sensing information for testing, corresponding to each of the frames for testing, into the metadata recognition module 200, to thereby allow the metadata recognition module 200 to (i) detect environment information on surroundings of the moving subject through a perception module (not illustrated) and (ii) detect position information on the moving subject through a localization & mapping module (not illustrated).

And, the perception module may include an object detection network based on deep learning and a segmentation network based on the deep learning, etc. Also, the metadata recognition module 200 may generate each piece of the metadata for testing corresponding to each of the frames for testing by using each piece of the sensing information for testing and each of results of analyzing each of the test images based on the deep learning.

Also, each piece of the metadata for testing corresponding to each of the frames for testing may include each of object bounding boxes corresponding to each of the objects for testing, each piece of pose information on the moving subject, traffic lights, traffic signs, and each piece of map information corresponding to a location of the moving subject, but the scope of the present disclosure is not limited thereto, and may include various information to be used for one or more behavior predictions for testing.

Then, the behavior prediction device 1000 may perform or support another device to perform a process of inputting each piece of the metadata for testing, corresponding to each of the frames for testing, into the feature encoding module 300, to thereby allow the feature encoding module 300 to encode each piece of the metadata for testing corresponding to each of the frames for testing and thus to output each of features for testing, corresponding to each of the frames for testing, to be used for the behavior predictions for testing.

Next, the behavior prediction device 1000 may perform or support another device to perform a process of inputting each of the test images, each piece of the metadata for testing, and each of the features for testing, corresponding to each of the frames for testing, into the explaining module 600, to thereby allow the explaining module 600 to generate each piece of explanation information for testing on each of affecting factors for testing determined as affecting the behavior predictions for testing for each of the frames for testing. Herein, the explanation information for testing may be explanation data on situations the objects for testing are in on the test images.

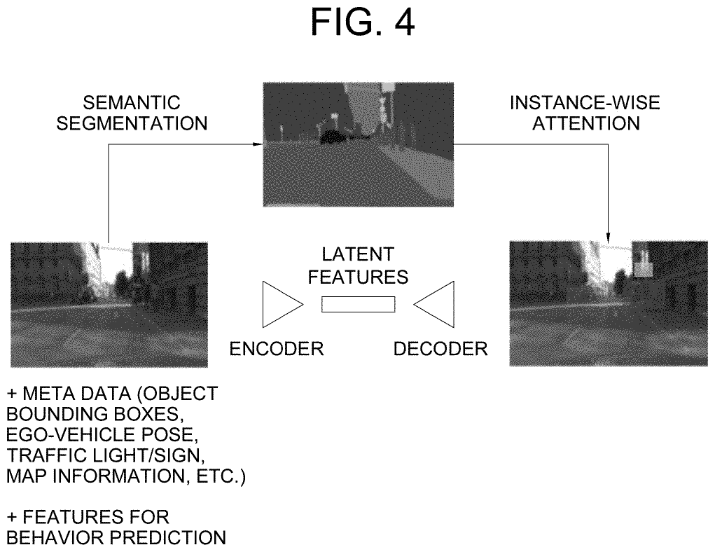

Specifically, by referring to FIG. 4, the behavior prediction device 1000 may perform or support another device to perform a process of instructing the explaining module 600 to (i) reduce dimensions of each of the test images, each piece of the metadata for testing, and each of the features for testing, corresponding to each of the frames for testing, to thereby generate each of latent features for testing corresponding to each of the frames for testing, through an encoder of an autoencoder and (ii) reconstruct each of the latent features for testing and mark each of the affecting factors for testing, determined as affecting the behavior predictions for testing, as each of one or more areas of interest (AOIs) for testing, to thereby generate each piece of the explanation information for testing, through a decoder of the autoencoder.

That is, the behavior prediction device 1000 may perform or support another device to perform a process of instructing the explaining module 600 to (i) (i-1) apply the learning operation to each of the test images, each piece of the metadata for testing, and each of the features for testing, corresponding to each of the frames for testing, to thereby generate each of semantic segmentation images for testing corresponding to each of the frames for testing and (i-2) identify instance-wise areas of interest on the semantic segmentation images for testing, through the autoencoder, and (ii) generate each of explanation images for testing, corresponding to each of the frames for testing, where the affecting factors for testing are marked by referring to results of said (i-2).

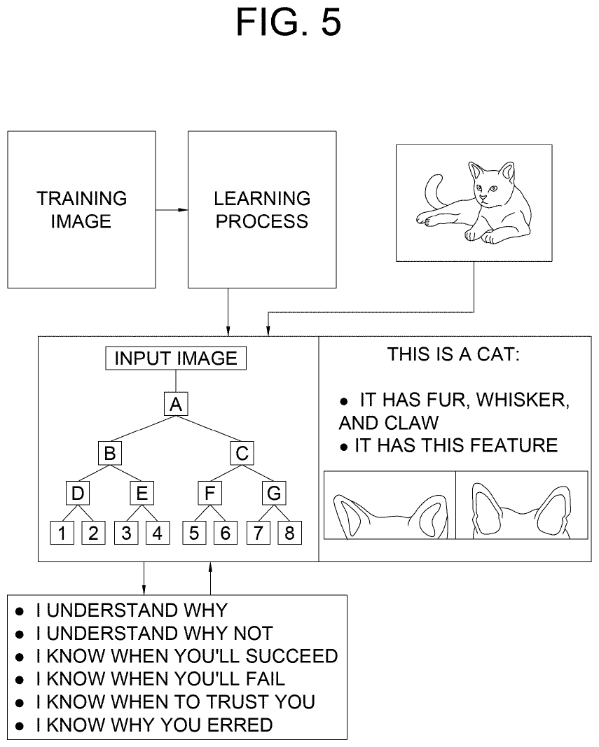

Also, by referring to FIG. 5, the behavior prediction device 1000 may perform or support another device to perform a process of instructing the explaining module 600 to apply the learning operation to each piece of the metadata for testing corresponding to each of the frames for testing, to thereby generate decision trees for testing based on the metadata for testing related to all of the objects for testing on the test images.

As one example, if an object is recognized as a “cat”, the explaining module 600 may generate a decision tree by using aspects of recognizing colors, shapes, etc. causing the object to be recognized as a “cat”. As a result, a user may understand how a learning network recognizes the object as a “cat” by referring to the decision tree and may also see why the learning network makes an error in recognizing the object.

By referring to FIG. 3 again, the behavior prediction device 1000 may perform or support another device to perform a process of inputting each of the test images and each piece of the metadata for testing, corresponding to each of the frames for testing, into the self-focused attention module 700, to thereby allow the self-focused attention module 700 to output each of attention maps for testing corresponding to each of the frames for testing. Herein, each of the attention maps for testing may be created by marking, through the learning operation, each of the areas of interest (AOIs) for testing corresponding to each of the objects for testing, to be used for the behavior predictions for testing, on each of the test images corresponding to each of the frames for testing.

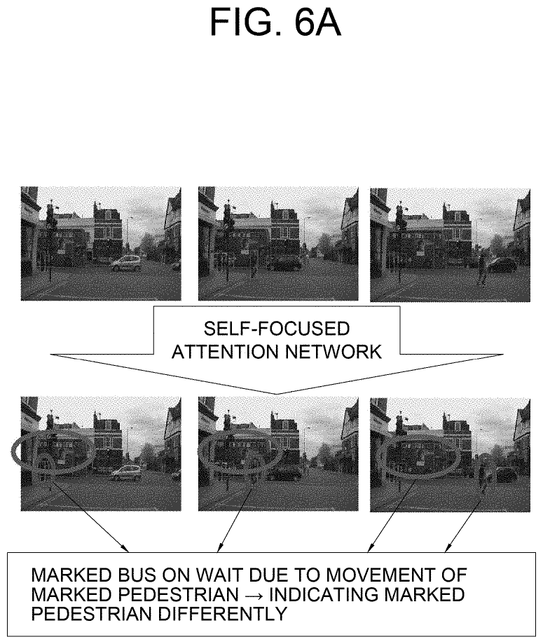

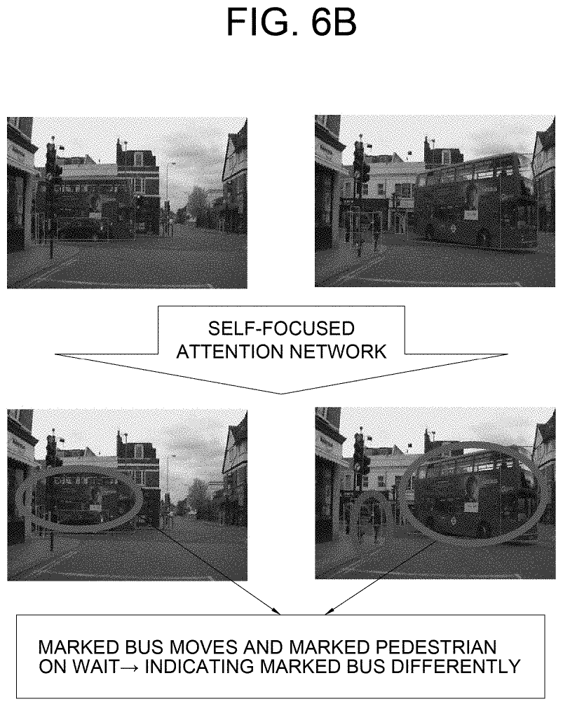

As one example, by referring to FIGS. 6A and 6B, as a result of analyzing based on the deep learning, each of the images and each piece of the metadata corresponding to each of the frames taken by the camera while the autonomous vehicle is driven, if a marked bus is determined as on wait due to movement of a marked pedestrian, the marked pedestrian may be indicated differently (not illustrated) from the marked bus to allow the user to pay attention to the marked pedestrian as shown in FIG. 6A, and if the marked bus starts and the marked pedestrian is determined as on wait, the marked bus may be indicated differently (not illustrated) from, the marked pedestrian to allow the user to pay attention to the marked pedestrian as shown in FIG. 6B.

Next, the behavior prediction device 1000 may perform or support another device to perform a process of inputting each of the features for testing and each of the attention maps for testing, corresponding to each of the frames for testing, into the behavior prediction module 400, to thereby allow the behavior prediction module 400 to analyze each of the features for testing and each of the attention maps for testing, corresponding to each of the frames for testing and predict each of one or more behaviors of each of the objects for testing, through the learning operation, and thus to generate each of the behavior predictions for testing.

Meanwhile, as another example different from predicting each of the trajectories of each of all of the objects on the images, the behavior prediction device 1000 may perform or support another device to perform a process of predicting each of the trajectories only of each of a part of the objects marked by using each of the attention maps.

Herein, the behavior prediction module 400 may include an RNN (Recurrent Neural Network) which adopts at least one of an LSTM (Long Short-Term Memory) algorithm and an LSTM-GAN (Generative Adversarial Network) algorithm.

Next, the behavior prediction device 1000 may perform or support another device to perform a process of allowing the outputting module 500 to output each of the behavior results for testing of each of the objects for testing, corresponding to each of the behavior predictions for testing. Simultaneously, the behavior prediction device 1000 may perform or support another device to perform a process of allowing the visualization module 800 to visualize and output the affecting factors for testing determined as affecting the behavior predictions for testing by referring to the explanation information for testing and the behavior results for testing.

Specifically, the behavior prediction device 1000 may perform or support another device to perform a process of instructing the visualization module 800 to mark at least one target object as one of the areas of interest (AOIs) for testing on each of the test images and to output each of the marked test images, by referring to the behavior predictions for testing and the explanation information for testing. Herein, the target object may be determined as affecting the behavior predictions for testing in each of the frames for testing.

Also, the behavior prediction device 1000 may perform or support another device to perform a process of instructing the visualization module 800 to output state information on at least one target object, determined as affecting the behavior predictions for testing in each of the frames for testing, by referring to the decision trees for testing and the explanation information for testing.

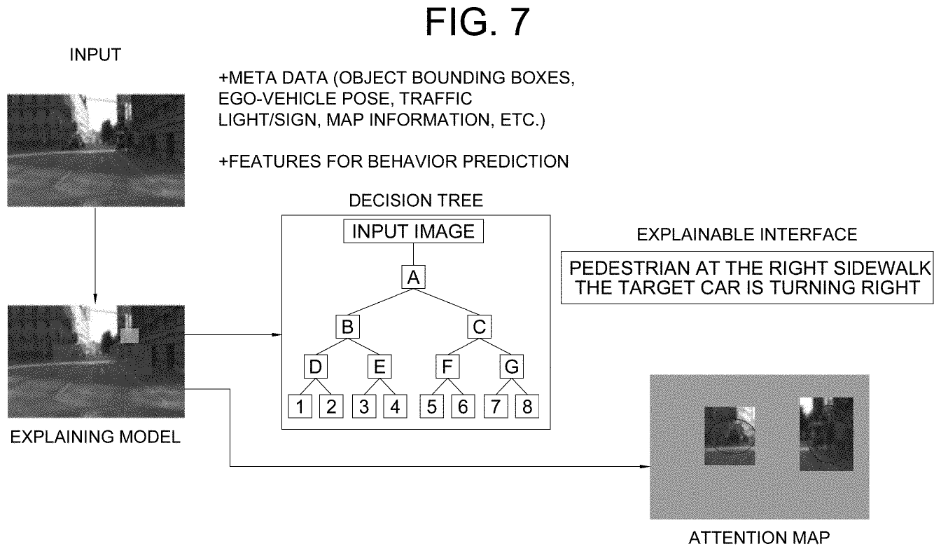

As one example, by referring to FIG. 7, the visualization module 800 may perform or support another device to perform a process of visually displaying each state of the pedestrian and a target car according to its corresponding piece of explanation information by referring to the decision trees or a process of visually displaying a specific attention map of the pedestrian and the target car.

Meanwhile, the explaining module 600 and the self-focused attention module 700 of the behavior prediction device 1000 may have been trained by a learning device.

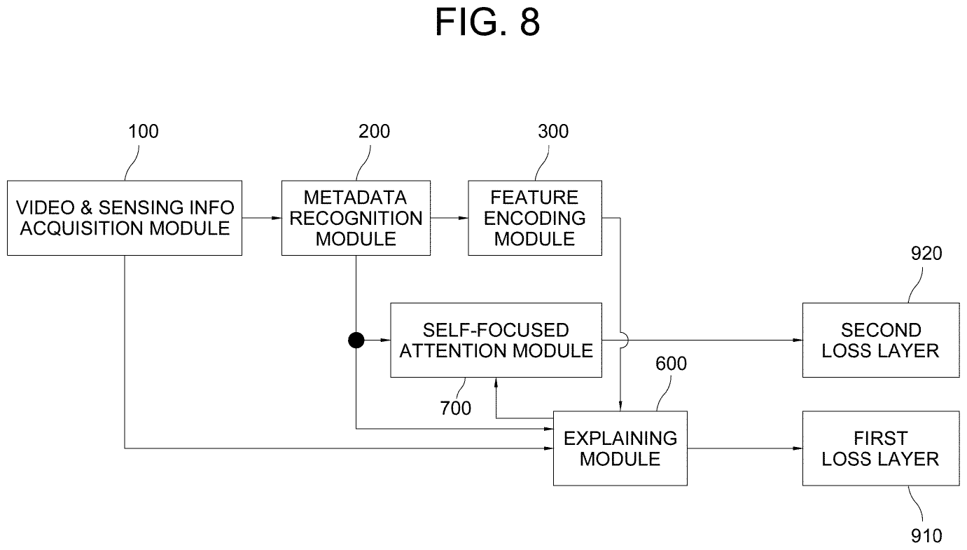

That is, by referring to FIG. 8, the learning device 200 may have trained the explaining module 600 and the self-focused attention module 700 by performing or supporting another device to perform (i) a process of inputting each of training images corresponding to each of frames for training and each piece of sensing information for training, corresponding to each of the frames for training, into the metadata recognition module 200, to thereby allow the metadata recognition module 200 to output each piece of metadata for training corresponding to each of the frames for training, (ii) a process of inputting each piece of the metadata for training into the feature encoding module 300, to thereby allow the feature encoding module 300 to encode each piece of the metadata for training and thus to output each of features for training, corresponding to each of the frames for training, to be used for one or more behavior predictions for training, (iii) a process of inputting each of the training images, each piece of the metadata for training, and each of the features for training into the explaining module 600, to thereby allow the explaining module 600 to generate each piece of explanation information for training corresponding to each of the frames for training, on each of affecting factors for training determined as affecting the behavior prediction for training for each of the frames for training, (iv) a process of inputting each piece of the explanation information for training and each piece of the metadata for training into the self-focused attention module 700, to thereby allow the self-focused attention module 700 to analyze the explanation information for training and the metadata for training and thus to output each of attention maps for training, corresponding to each of the frames for training, created by marking one or more areas of interest (AOIs) for training, for the behavior prediction for training, corresponding to each of the frames for training, and (v) a process of minimizing (v-1) each of one or more explanation losses calculated by referring to each piece of the explanation information for training and its corresponding each of explanation ground truths and (v-2) each of one or more attention losses calculated by referring to each of the attention maps for training and its corresponding each of attention ground truths. Herein, the explanation information for training may be explanation data on situations the objects for training are in on the training images.

Herein, the learning device 2000 may include a memory (not illustrated) for storing instructions to train the explaining module 600 and the self-focused attention module 700 of the behavior prediction device 1000 and a processor (not illustrated) for performing processes of training the explaining module 600 and the self-focused attention module 700 of the behavior prediction device 1000 according to the instructions in the memory.

Specifically, the learning device 2000 may typically achieve a desired system performance by using combinations of at least one computing device and at least one computer software, e.g., a computer processor, a memory, a storage, an input device, an output device, or any other conventional computing components, an electronic communication device such as a router or a switch, an electronic information storage system such as a network-attached storage (NAS) device and a storage area network (SAN) as the computing device and any instructions that allow the computing device to function in a specific way as the computer software.

The processor of the computing device may include hardware configuration of MPU (Micro Processing Unit) or CPU (Central Processing Unit), cache memory, data bus, etc. Additionally, the computing device may further include software configuration of OS and applications that achieve specific purposes.

However, such description of the computing device does not exclude an integrated device including any combination of a processor, a memory, a medium, or any other computing components for implementing the present disclosure.

Processes of training the explaining module 600 and the self-focused attention module 700 of the behavior prediction device 1000 by using the learning device 2000 configured as such are described by referring to FIG. 8 as follows. In the description below, the part easily deducible from the explanation of FIG. 3 will be omitted.

First, the learning device 2000 may perform or support another device to perform a process of acquiring (1) each of the training images corresponding to each of the frames for training and (2) each piece of the sensing information for training corresponding to each of the frames for training through the video & sensing information acquisition module 100.

And, the behavior prediction device 2000 may perform or support another device to perform a process of inputting each of the training images corresponding to each of the frames for training and each piece of the sensing information for training, corresponding to each of the frames for training, into the metadata recognition module 200, to thereby allow the metadata recognition module 200 to output each piece of the metadata for training corresponding to each of the frames for training.

Then, the learning device 2000 may perform or support another device to perform a process of inputting each piece of the metadata for training, corresponding to each of the frames for training, into the feature encoding module 300, to thereby allow the feature encoding module 300 to encode each piece of the metadata for training corresponding to each of the frames for training and thus to output each of the features for training, corresponding to each of the frames for training, to be used for the behavior predictions for training.

Next, the learning device 2000 may perform or support another device to perform a process of inputting each of the training images, each piece of the metadata for training, and each of the features for training, corresponding to each of the frames for training, into the explaining module 600, to thereby allow the explaining module 600 to generate each piece of the explanation information for training on each of the affecting factors for training determined as affecting the behavior prediction for training for each of the frames for training.

Next, the learning device 2000 may perform or support another device to perform a process of inputting each piece of the explanation information for training and each piece of the metadata for training, corresponding to each of the frames for training, into the self-focused attention module 700, to thereby allow the self-focused attention module 700 to analyze each piece of the explanation information for training and each piece of the metadata for training and thus to output each of the attention maps for training corresponding to each of the frames for training. Herein, each of the attention maps for training may be created by marking the areas of interest (AOIs) for training, to be used for the behavior predictions for training.

Thereafter, the learning device 2000 may perform or support another device to perform a process of training the explaining module 600 and the self-focused attention module 700 such that (1) each of the explanation losses calculated by referring to each piece of the explanation information for training and its corresponding each of explanation ground truths and (2) each of the attention losses calculated by referring to each of the attention maps for training and its corresponding each of attention ground truths are minimized. Herein, the learning device 2000 may perform or support another device to perform (i) a process of allowing a first loss layer 910 to calculate each of the explanation losses by referring to each piece of the explanation information for training and its corresponding each of the explanation ground truths and (ii) a process of allowing a second loss layer 920 to calculate each of the attention losses by referring to each of the attention maps for training and its corresponding each of attention ground truths.

Meanwhile, the explaining module 600 and the self-focused attention module 700 are described above as trained by using each of the training images and its corresponding each piece of the sensing information for training. However, as another example, training data may be generated, into which each of the training images and its corresponding each piece of the sensing information for training, each piece of the metadata for training, and each of the features for training are incorporated, and the explaining module 600 and the self-focused attention module 700 may be trained using the training data generated as such.

The present disclosure has an effect of allowing information on the affecting factors, determined as affecting the behavior predictions by the behavior prediction network, to be provided to the user.

The present disclosure has another effect of allowing the user to pay attention to the AOIs to be marked when the behavior predictions of an object are performed by the behavior prediction network.

The present disclosure has still another effect of improving a performance of the behavior prediction network efficiently by using the affecting factors determined as affecting the behavior predictions.

The embodiments of the present disclosure as explained above can be implemented in a form of executable program command through a variety of computer means recordable to computer readable media. The computer readable media may include solely or in combination, program commands, data files, and data structures. The program commands recorded to the media may be components specially designed for the present disclosure or may be usable to those skilled in the art. Computer readable media include magnetic media such as hard disk, floppy disk, and magnetic tape, optical media such as CD-ROM and DVD, magneto-optical media such as floptical disk and hardware devices such as ROM, RAM, and flash memory specially designed to store and carry out program commands. Program commands include not only a machine language code made by a complier but also a high level code that can be used by an interpreter etc., which is executed by a computer. The aforementioned hardware device can work as more than a software module to perform the action of the present disclosure and vice versa.

As seen above, the present disclosure has been explained by specific matters such as detailed components, limited embodiments, and drawings. They have been provided only to help more general understanding of the present disclosure. It, however, will be understood by those skilled in the art that various changes and modification may be made from the description without departing from the spirit and scope of the disclosure as defined in the following claims.

Accordingly, the thought of the present disclosure must not be confined to the explained embodiments, and the following patent claims as well as everything including variations equal or equivalent to the patent claims pertain to the category of the thought of the present disclosure.

1. A method for predicting behavior using explainable self-focused attention, comprising steps of:
(a) a behavior prediction device, if (1) a video for testing taken by a camera mounted on a moving subject where the behavior prediction device is installed and (2) sensing information for testing detected by one or more sensors mounted on the moving subject are acquired, performing (i) a process of inputting one or more test images corresponding to one or more frames for testing on the video for testing and each piece of the sensing information for testing into a metadata recognition module, to thereby allow the metadata recognition module to output each piece of metadata for testing, and (ii) a process of inputting the metadata for testing into a feature encoding module, to thereby allow the feature encoding module to encode the metadata for testing and thus to output one or more features for testing;
(b) the behavior prediction device performing (i) a process of inputting each of the test images, each piece of the metadata for testing, and each of the features for testing into an explaining module, to thereby allow the explaining module to generate one or more pieces of explanation information for testing, (ii) a process of inputting each of the test images and each piece of the metadata for testing into a self-focused attention module, to thereby allow the self-focused attention module to output one or more attention maps for testing, wherein each of the attention maps for testing is created by marking one or more areas of interest (AOIs) for testing on each of the test images, and (iii) a process of inputting each of the features for testing and each of the attention maps for testing into a behavior prediction module, to thereby allow the behavior prediction module to analyze the features for testing and the one or more attention maps for testing and predict one or more behaviors of one or more objects for testing and thus generate one or more behavior predictions for testing; and
(c) the behavior prediction device performing a process of allowing an outputting module to output one or more behavior results for testing, corresponding to each of the behavior predictions for testing, of each of the objects for testing.

2. The method of claim 1, wherein a learning device has trained the explaining module and the self-focused attention module by performing:
(i) a process of inputting one or more training images corresponding to one or more frames for training and each piece of sensing information for training corresponding to each of the frames for training into the metadata recognition module, to thereby allow the metadata recognition module to output each piece of metadata for training corresponding to each of the frames for training, (ii) a process of inputting the metadata for training into the feature encoding module, to thereby allow the feature encoding module to encode the metadata for training and thus to output one or more features for training, corresponding to each of the frames for training, (iii) a process of inputting each of the training images, each piece of the metadata for training, and each of the features for training into the explaining module, to thereby allow the explaining module to generate pieces of explanation information for training corresponding to each of the frames for training, (iv) a process of inputting each piece of the explanation information for training and each piece of the metadata for training into the self-focused attention module, to thereby allow the self-focused attention module to analyze the explanation information for training and the metadata for training and thus to output one or more attention maps for training corresponding to each of the frames for training wherein each of the attention maps for training is created by marking one or more areas of interest for training, to be used for the behavior predictions for training, corresponding to each of the frames for training, and (v) a process of minimizing (v-1) each of one or more explanation losses calculated by referring to each piece of the explanation information for training and corresponding explanation ground truths and (v-2) each of one or more attention losses calculated by referring to each of the attention maps for training and corresponding attention ground truths.

3. The method of claim 1, wherein, at the step of (b), the behavior prediction device performs a process of instructing the explaining module to (i) reduce dimensions of the test images, the metadata for testing, and the features for testing, to thereby generate one or more latent features for testing, through an encoder of an autoencoder and (ii) reconstruct each of the latent features for testing, to thereby generate each piece of the explanation information for testing, through a decoder of the autoencoder.

4. The method of claim 3, wherein, at the step of (c), the behavior prediction device performs a process of instructing the visualization module to mark at least one target object as one of the areas of interest for testing on each of the test images and to output each of the marked test images, by referring to the behavior predictions for testing and the explanation information for testing, wherein the target object is determined as affecting the behavior predictions for testing in each of the frames for testing.

5. The method of claim 1, wherein, at the step of (b), the behavior prediction device generate one or more semantic segmentation images for testing and (i-2) identify instance-wise areas of interest on the semantic segmentation images for testing, through the autoencoder, and (ii) generate one or more explanation images for testing.

6. The method of claim 1, wherein, at the step of (b), the behavior prediction device generates decision trees for testing based on the metadata for testing related to all of the objects for testing on the test images.

7. The method of claim 6, wherein, at the step of (c), the behavior prediction device performs a process of instructing the visualization module to output state information on at least one target object, determined as affecting the behavior predictions for testing in each of the frames for testing, by referring to the decision trees for testing and the explanation information for testing.

8. The method of claim 1, wherein, at the step of (a), the behavior prediction device performs a process of inputting the test images and the sensing information for testing into the metadata recognition module, to thereby allow the metadata recognition module to (1) detect environment information on surroundings of the moving subject through a perception module and (2) detect position information on the moving subject through a localization and mapping module.

9. The method of claim 1, wherein each piece of the metadata for testing includes one or more object bounding boxes corresponding to each of the objects for testing, each piece of pose information on the moving subject, and each piece of map information corresponding to a location of the moving subject.

10. The method of claim 1, wherein the behavior prediction module includes an RNN (Recurrent Neural Network) which adopts at least one of an LSTM (Long Short-Term Memory) algorithm and an LSTM-GAN (Generative Adversarial Network) algorithm.

11. A behavior prediction device for predicting behavior using explainable self-focused attention, comprising:
at least one memory that stores instructions; and
at least one processor configured to execute the instructions to perform: (I) if (1) a video for testing taken by a camera mounted on a moving subject where the behavior prediction device is installed and (2) sensing information for testing detected by one or more sensors mounted on the moving subject are acquired, (i) a process of inputting one or more test images corresponding to one or more frames for testing on the video for testing and each piece of the sensing information for testing into a metadata recognition module, to thereby allow the metadata recognition module to output each piece of metadata for testing, and (ii) a process of inputting the metadata for testing into a feature encoding module, to thereby allow the feature encoding module to encode the metadata for testing and thus to output one or more features for testing, (II) (i) a process of inputting each of the test images, each piece of the metadata for testing, and each of the features for testing into an explaining module, to thereby allow the explaining module to generate pieces of explanation information for testing, (ii) a process of inputting each of the test images and each piece of the metadata for testing into a self-focused attention module, to thereby allow the self-focused attention module to output one or more attention maps for testing wherein each of the attention maps for testing is created by marking one or more areas of interest (AOIs) for testing on each of the test images, and (iii) a process of inputting each of the features for testing and each of the attention maps for testing into a behavior prediction module, to thereby allow the behavior prediction module to analyze the features for testing and the attention maps for testing and predict one or more behaviors of one or more objects for testing and thus generate the behavior predictions for testing, and (III) (i) a process of allowing an outputting module to output one or more behavior results for testing, corresponding to each of the behavior predictions for testing, of each of the objects for testing and (ii) a process of referring to the explanation information for testing and the behavior results for testing.

12. The behavior prediction device of claim 11, wherein a learning device has trained the explaining module and the self-focused attention module by performing:
(i) a process of inputting one or more training images corresponding to one or more frames for training and each piece of sensing information for training corresponding to each of the frames for training into the metadata recognition module, to thereby allow the metadata recognition module to output each piece of metadata for training corresponding to each of the frames for training, (ii) a process of inputting the metadata for training into the feature encoding module, to thereby allow the feature encoding module to encode the metadata for training and thus to output one or more features for training, corresponding to each of the frames for training, (iii) a process of inputting each of the training images, each piece of the metadata for training, and each of the features for training into the explaining module, to thereby allow the explaining module to generate pieces of explanation information for training corresponding to each of the frames for training, (iv) a process of inputting each piece of the explanation information for training and each piece of the metadata for training into the self-focused attention module, to thereby allow the self-focused attention module to analyze the explanation information for training and the metadata for training and thus to output one or more attention maps for training corresponding to each of the frames for training wherein each of the attention maps for training is created by marking one or more areas of interest for training, to be used for the behavior predictions for training, corresponding to each of the frames for training, and (v) a process of minimizing (v-1) each of one or more explanation losses calculated by referring to each piece of the explanation information for training and corresponding explanation ground truths and (v-2) each of one or more attention losses calculated by referring to each of the attention maps for training and corresponding attention ground truths.

13. The behavior prediction device of claim 11, wherein, at the process of (II), the processor performs a process of instructing the explaining module to (i) reduce dimensions of the test images, the metadata for testing, and the features for testing, to thereby generate one or more latent features for testing, through an encoder of an autoencoder and (ii) reconstruct each of the latent features for testing, to thereby generate each piece of the explanation information for testing, through a decoder of the autoencoder.

14. The behavior prediction device of claim 13, wherein, at the process of (III), the processor performs a process of instructing the visualization module to mark at least one target object as one of the areas of interest for testing on each of the test images and to output each of the marked test images, by referring to the behavior predictions for testing and the explanation information for testing, wherein the target object is determined as affecting the behavior predictions for testing in each of the frames for testing.

15. The behavior prediction device of claim 11, wherein, at the process of (II), the processor generates one or more semantic segmentation images for testing and (i-2) identify instance-wise areas of interest on the semantic segmentation images for testing, through the autoencoder, and (ii) generate one or more explanation images for testing.

16. The behavior prediction device of claim 11, wherein, at the process of (II), the processor generates decision trees for testing based on the metadata for testing related to all of the objects for testing on the test images.

17. The behavior prediction device of claim 16, wherein, at the process of (III), the processor performs a process of instructing the visualization module to output state information on at least one target object, determined as affecting the behavior predictions for testing in each of the frames for testing, by referring to the decision trees for testing and the explanation information for testing.

18. The behavior prediction device of claim 11, wherein, at the process of (I), the processor performs a process of inputting the test images and the sensing information for testing into the metadata recognition module, to thereby allow the metadata recognition module to (1) detect environment information on surroundings of the moving subject through a perception module and (2) detect position information on the moving subject through a localization and mapping module.

19. The behavior prediction device of claim 11, wherein each piece of the metadata for testing includes one or more object bounding boxes corresponding to each of the objects for testing, each piece of pose information on the moving subject, and each piece of map information corresponding to a location of the moving subject.

20. The behavior prediction device of claim 11, wherein the behavior prediction module includes an RNN (Recurrent Neural Network) which adopts at least one of an LSTM (Long Short-Term Memory) algorithm and an LSTM-GAN (Generative Adversarial Network) algorithm.
